(19) United States
(12) Patent Application Publication
(10) Pub. No.: US 2015/0012647 A1
(43) Pub. Date: Jan. 8, 2015

(54) ROUTER-BASED END-USER PERFORMANCE MONITORING

(71) Applicant: Remasys PTY LTD, Melbourne (AU)

(72) Inventor: Roland Grelewicz, Mentone (AU)

(73) Assignee: Remasys PTY LTD, Melbourne (AU)

(21) Appl. No.: 14/380,889

(22) PCT Filed: Feb. 22, 2013
(86) PCT No.: PCT/AU2013/000168

§ 371 Date: Aug. 25, 2014

(30) Foreign Application Priority Data
Feb. 24, 2012 (AU) 2012900694

(51) Int. Cl. H04L 12/26; G06F 3/0488; G06F 3/0484; H04L 29/08

(52) U.S. Cl. CPC H04L 43/045; H04L 67/10; G06F 3/04886; G06F 3/04847
USPC 709/224

(57) ABSTRACT

A method (600) of obtaining end-user performance data associated with a target application executing at a predetermined location within a distributed information system, includes providing a network element (400) of the distributed information system proximate to the predetermined location. The network element (400) is configured to provide a primary network operations function, such as a router function (402), and further comprises an integrated applications execution environment (408) configured to operate substantially independently of the primary network operations function. The method further comprises executing (604) the target application within the integrated applications execution environment and performing (606) at least one automated operation of the target application by emulating user actions within the integrated applications execution environment. One or more images of a target application virtual display is captured (608) from within the integrated applications execution environment. Performance data of the target application are determined (610) by analysis of the captured images of the target application virtual display, and stored (612) in a memory store (614).

### FIELD OF THE INVENTION

The present invention relates to monitoring of performance in distributed information systems, and in particular to a method and system for monitoring the end-user experience of applications executing at remote sites within a distributed information system. Embodiments of the invention may be applied, for example to monitor the performance of applications executing within a branch network of an organisation such as a financial services provider, e.g. a bank.

### BACKGROUND OF THE INVENTION

Businesses and their customers are increasingly dependent upon distributed information systems for the efficient delivery of services. As a consequence, the performance and reliability of end-user applications executing within those information systems is critical to business performance and success. Monitoring the performance of the information systems, and identifying or preventing failures in a timely manner is therefore of vital importance.

Traditional methods of monitoring the performance of distributed information systems have typically fallen into one of two categories. The first category, sometimes known as ‘real-user monitoring’, involves the passive observation of activity and traffic within the information system. According to this technique, various agents and network probes gather statistical information regarding the actual, i.e. ‘real-user’, traffic and operations within the system, and attempt to use this information to infer overall health and performance of the system.

The second traditional category of performance monitoring is often known as ‘synthetic transaction monitoring’ or ‘active monitoring’. According to this technique, one or more appliances deployed within the network generate synthetic transactions, e.g. by injecting data packets into the network, or making service calls to remote servers, and then detecting the resulting response packets or service responses. The monitoring system then endeavours to infer the user experience from the response metrics.

However, the effectiveness of real-user monitoring and synthetic transaction monitoring systems is limited in any non-trivial information system. Passive or active monitoring at the network or service call level does not take into account the application code executed in the client application. Even relatively sophisticated transaction monitoring solutions have difficulty determining the end-user experience, unless they can execute the application code in exactly the same way that the client application does. Furthermore, both passive and active monitoring approaches can encounter difficulties in obtaining relevant information in secure environments, where many transactions and associated data may be encrypted.

For example, in a typical web-based e-commerce application, a user will access a secure web site using SSL or TLS encrypted data transport, and download content which may include JavaScript, Flash, Java or other code. This code is executed within the web browser environment, and subsequently requests or uploads information from and to multiple application servers in order to obtain the data necessary to generate and render a meaningful display to the user. The application code executed within the browser environment can make web service requests, database calls, remote procedure calls, or simply send updates to third parties, such as Google Analytics. All of these operations, transmissions and transactions will influence the responsiveness of the application, and the end-user experience. No approach to user experience monitoring that is independent of the end-user application is capable of reliably measuring the end-user experience.

In addition to the retail environment (e.g. Internet banking, trading platforms, collaboration systems, payment systems, booking, shopping or other e-commerce systems) distributed information systems are also widely used within corporate environments. For example, many business and service organisations rely on a network of bricks and mortar branches to serve their customers, and to run their business operations. Such businesses include banks, accommodation providers, travel and transport providers, entertainment providers (e.g. cinemas, theatres and sporting venue), and so forth. Customer service in these environments is critically dependent on information systems performing reliably and well.

The information systems managers in such organisations often rely on help desk calls from users to identify issues associated with branch application availability and performance. In most cases it remains unclear whether, when and how a problem has occurred. The impact on users throughout the network may be unknown, i.e. whether the reported issue is localised, or is impacting users in a region or in the entire branch network. It may be unclear whether reported problems are intermittent or ongoing. User-provided information relating to availability and performance issues may be subjective, reporting may be delayed until a minor issue becomes critical, and in some cases real problems within the system may not be reported. The end result may be a negative user and customer sentiment, which may lead to low business productivity.

Furthermore, even when a problem has been escalated for investigation, identifying and resolving the root cause of the problem within a complex distributed information system is not easy. For example, for intermittently occurring problems there may be little or no reliable information to work from, due to the difficulty in observing issues as and when they occur.

There is, accordingly, a need for improved end-user experience monitoring solutions which are suitable for deployment within geographically distributed organisations, such as those dependent upon branch networks. It is an object of the invention to address this need.

### SUMMARY OF THE INVENTION

In one aspect, the invention provides a method of obtaining end-user performance data associated with a target application executing at a predetermined location within a distributed information system, the method comprising the steps of:

providing a network element of the distributed information system proximate to the predetermined location, which is configured to provide a primary network operations function, and which further comprises an integrated applications execution environment configured to operate substantially independently of the primary network operations function;

executing the target application within the integrated applications execution environment;

performing at least one automated operation of the target application by emulating user actions within the integrated applications execution environment;

capturing one or more images of a target application virtual display from within the integrated applications execution environment, comprising a graphical user interface responsive to the emulated user actions;

determining performance data of the target application by analysis of the captured images of the target application virtual display; and

storing the performance data in a memory store.

Advantageously, the method employs resources that have been deployed within existing network elements of the information system in order to implement an end-user experience monitoring function. In some embodiments, for example, the network element is a router, and the primary network operations function is the routing of data packets within the information system. As will be appreciated, routers are deployed throughout a distributed system, such as a branch network, including locations proximate to the end-users.

A number of further benefits are obtained by deploying integrated applications execution environments, e.g. virtualised computing platforms, within network elements such as routers. For example, the underlying hardware platform shares resources with the network element, thereby minimising associated power consumption, and avoiding the need to provide additional space and cabling for the installation of suitable monitoring appliances. The virtualised environment enables applications to be remotely deployed and provisioned, so that monitoring of end-user experience of any particular application at any location within the distributed information system may be initiated and controlled from any other location, such as an operations centre.

Preferably, automated operation of the target application includes execution of emulated keyboard and pointer actions. Advantageously, this enables the complete executing application, comprising all of the actual application code, to be driven manually or programmatically in a manner that directly represents actual end-user interactions with the application.

Emulated user actions may be generated as input events to the target application via the integrated applications execution environment.

In embodiments of the invention, analysis of the captured image comprises capturing one or more images, and analysing the images to detect a response to the emulated user actions. Accordingly, embodiments of the invention provide the benefit of monitoring actual application response times, as experienced by the end-user, rather than inferring the end-user experience from lower-level data, transaction and service call response times.

The types of analysis that may be performed include: whether there is any response to the emulated user actions; measurement of the latency between an emulated user action and a corresponding response; and determining whether a response to the emulated user action is an expected response or an unexpected response. For example, the analysis may include detecting the generation of display screens corresponding with time-outs, or other error conditions.

In embodiments of the invention, data gathered by the analysis of images captured from the virtual environment is used to compute derived performance indicators of the system, including the target application.

Advantageously, it is also possible to capture and process sequences of virtual display images in order to generate a digital video recording of emulated actions and corresponding responses. Beneficially, these digital video recordings may be stored and made available for review by systems management and operations staff in order to observe the impact of a degradation in user experience even in the case of intermittent problems, which may not be ongoing at the relevant time.

In another aspect, the invention provides a system for obtaining end-user performance data associated with a target application executing at a predetermined location within a distributed information system, the system comprising:

a network element of the distributed information system proximate to the predetermined location, which is configured to provide a primary network operations function, and which further comprises an integrated applications execution environment configured to operate substantially independently of the primary network operations function,

wherein the integrated applications execution environment comprises a virtual client computing platform including a microprocessor and at least one associated memory device comprising stored program instructions and associated data, which when executed by the microprocessor cause the integrated applications execution environment to execute the steps of:
executing the target application on the virtual client computing platform;
performing at least one automated operation of the target application by emulating user actions within the integrated applications execution environment;
capturing one or more images of a target application virtual display from within the integrated applications execution environment, comprising a graphical user interface responsive to the emulated user actions;
determining performance data of the target application by analysis of the captured images of the target application virtual display; and
storing the performance data in a memory store.

The memory store may be collocated with the network element, e.g. in the form of a local hard disk drive, flash memory device, or the like.

Alternatively, the memory store may be remotely located, for example at a data centre of the distributed information system, and the performance data may be transmitted to the memory store via one or more network connections of the information system.

Further preferred features and advantages of the present invention will be apparent to those skilled in the art from the following description of preferred embodiments of the invention. It will be understood, however, that the preferred embodiments are not limiting of the scope of the invention as defined in any of the preceding statements, or in the claims appended hereto.

### BRIEF DESCRIPTION OF THE DRAWINGS

A preferred embodiment will now be described with reference to the accompanying drawings, wherein like reference numerals represent like features, and in which:

FIG. 1 is a schematic diagram of a systems architecture of a management system embodying the invention;

FIG. 2 is a schematic diagram of the systems management operation of the management system illustrated in FIG. 1;

FIG. 3 shows schematically an example of an information system, including a branch-office with multiple client terminals, in accordance with a preferred embodiment of the invention;

FIG. 4 is a block diagram illustrating a router architecture incorporating an integrated applications execution environment according to an embodiment of the invention;

FIG. 5 is a block diagram illustrating an embodiment of a system configuration for monitoring end-user performance of an application; and

FIG. 6 is a flowchart illustrating a process for router-based monitoring of the performance of one or more applications according to an embodiment of the invention.

### DETAILED DESCRIPTION OF PREFERRED EMBODIMENT

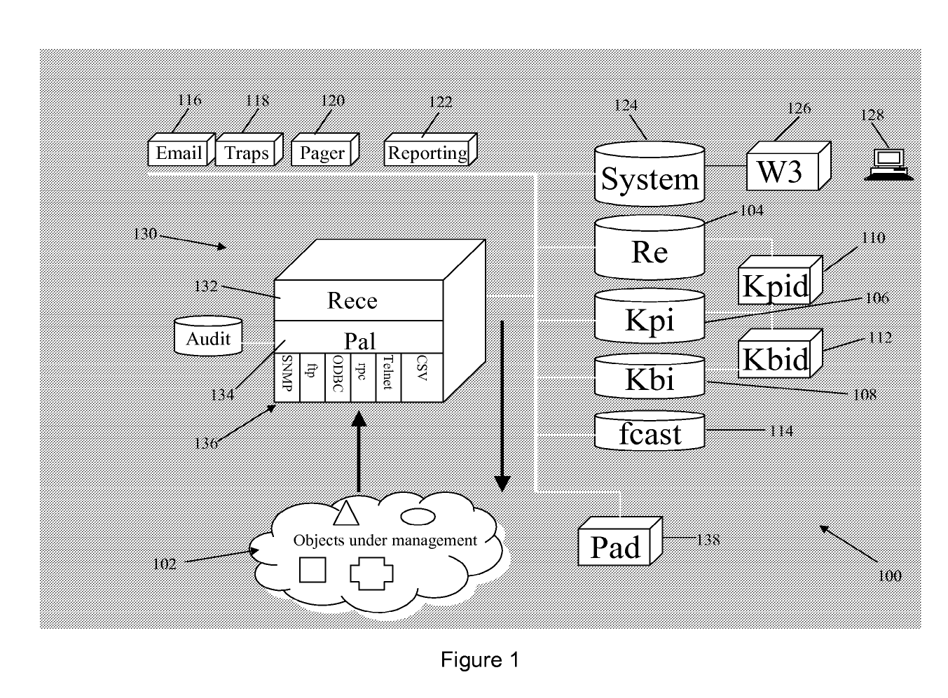

FIGS. 1, 2 and 3 illustrate schematically a management system architecture, the management operation software architecture, and an exemplary managed system, embodying the present invention.

A more-detailed disclosure of the operation of the management system 100 illustrated in FIG. 1 may be found in the specification of the commonly assigned U.S. Pat. No. 7,953,847. Accordingly, only those details pertinent to the implementation and operation of router-based monitoring embodying the present invention will be described herein, the further details of the management system being incorporated in their entirety from the aforementioned US patent specification by reference.

FIG. 1 shows a schematic diagram of the architecture 100 of a management system according to a preferred embodiment. The management system is managing a distributed computer system, represented by a collection of objects under management 102. The managed objects 102 typically include applications, computing resources, network resources, and other software and hardware resources making up the system under management. In embodiments of the present invention the managed objects include one or more applications and other resources hosted within a router-based virtual environment.

The management system 100 collects management information relevant to the performance of the information system from the objects under management 102. The management information typically consists of various performance metrics and other status data maintained by the resources in the system. This data is gathered from the managed resources using a heterogenous range of protocols. The basic data obtainable from the objects under management 102 is called Raw Element (RE) information, which is collected and stored in a Raw Elements database 104.

Expert knowledge of the system under management is embodied in performance indicators that may be understood as abstractions of the raw management information available from the objects under management 102. In a preferred embodiment, a distinction is made between two types of performance indicator. These are key performance indicators (KPIs) that generally represent aspects of the technical performance of an information system, and which are stored in a KPI database 106, and key business indicators (KBIs), which generally represent measures of the performance of the system relative to business objectives, and which are stored in a KBI database 108.

A database of forecast information 114, includes forecasted values of any selected raw elements, KPIs, and KBIs. Reporting processes are preferably provided, including process 116 for sending email reports to operators, process 118 for generating traps relating to events that occur in the system, process 120 for generating pager alerts and alarms, and process 112 for providing general reporting of the status and performance of the management system, as well as the system under management.

A system database 124 defines the initial state of the system and maintains the system's operational state. Functions and information maintained by system database 124 include a job scheduler, job definitions, performance indicator (KPI and KBI) definitions, alert definitions, user definitions, system normalisation data, and definitions used by a proactive correction engine 138.

Preferably, a web server process 126 is provided, enabling the system to be remotely accessed and operated using a web browser running on any desktop PC, e.g. 128.

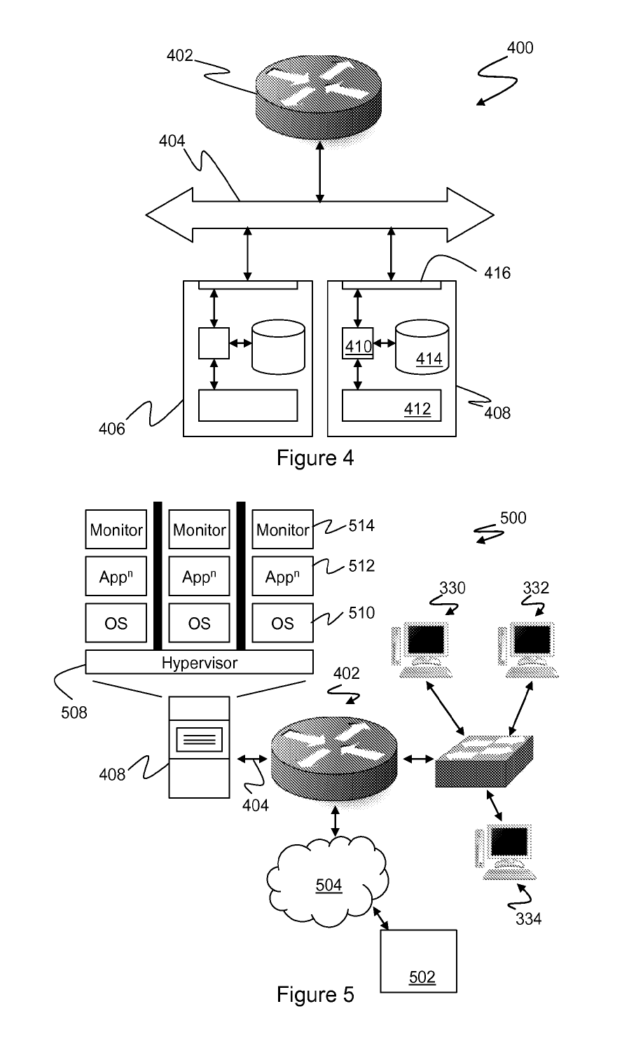

An object management module 130 includes a Raw Element Collection Engine (RECE) 132, a Protocol Abstraction Layer (PAL) 134, and various protocol modules 136 that may be used to communicate and gather information from the objects under management 102. The provision of multiple protocol interfaces 136 and the protocol abstraction layer 134 provides the management system 100 with the ability to manage any type of object without reliance upon intrusive agents or limited and unreliable SNMP MIB information. The specific means and methods employed in preferred embodiments of the invention, for obtaining data from router-hosted applications, are described below with reference to FIGS. 4, 5 and 6.

The RECE 132 coordinates the collection of management information from the objects under management 102. The RECE 132 incorporates a job scheduler that runs specified collection jobs at predetermined intervals. Accordingly, each RE has a corresponding resolution period, being the interval between executions of the jobs that is responsible for correcting the RE.

A proactive correction engine 138 is preferably included, to detect possible faults in the system under management, and take corrective action where possible.

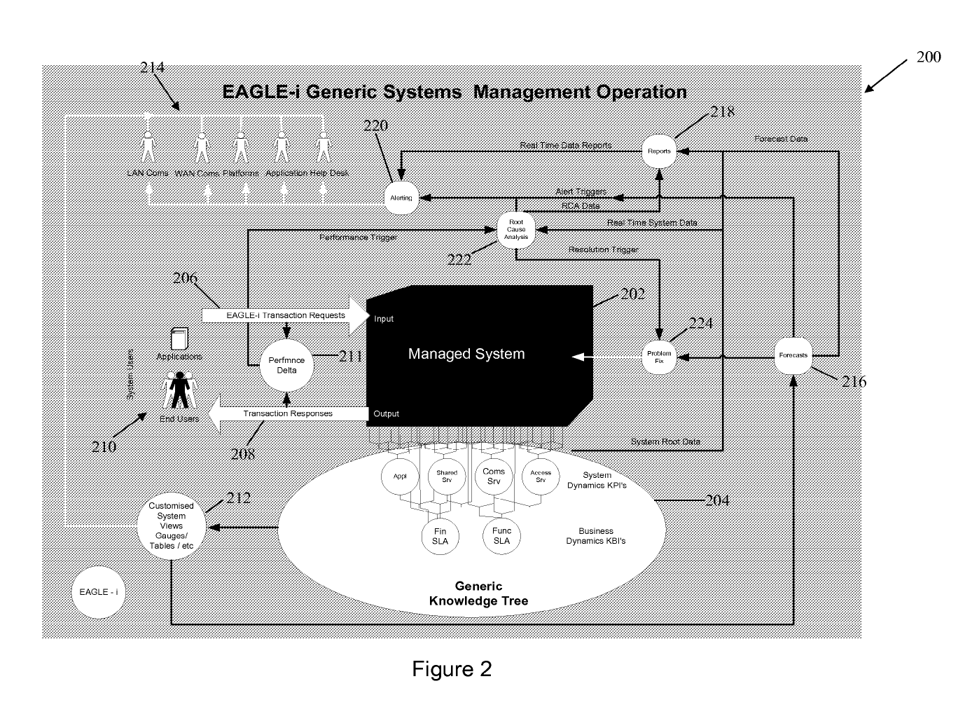

Turning now to FIG. 2, there is shown a schematic diagram of the system management operation 200 of the preferred embodiment of the invention. The management system is configured to manage an information system 202. The preferred embodiment of the invention includes a ‘knowledge tree’ 204, which is a knowledge base having a hierarchical conceptual structure that may embody a substantial amount of expert knowledge relating to the system under management 202. The knowledge tree 204 may be understood to embody a management model of the managed information system 202, which may be configured using expert knowledge of the managed information system 202.

The management operation of the preferred embodiment includes generating transaction requests 206 to the information system under management 202, and monitoring the performance of the system in providing corresponding transaction responses 208. The generation of transaction requests may be carried out under the control of the job scheduler in the RECE 132. It is desirable that transaction requests be generated from applications and end-users 210 of the managed information system 202, to ensure that the transaction performance of the managed system 202 reflects the actual performance experienced by end-users in relation to the profile of tasks usually required by the end-users. Various methods for generating such transaction requests in relation to fixed infrastructure and resources, such as servers and desktop client computers, are described in greater detail in U.S. Pat. No. 7,953,847. Means and methods embodying the present invention are described below with reference to FIGS. 4 to 6.

Any changes in performance, represented by performance delta 211 in the management operation diagram 200, may thereby be detected. Accordingly, degradations in end-user performance and/or experience may be identified and used to trigger an analysis 222 of the root causes of such performance degradation. A particular advantage of the preferred embodiment of the management system 100 is that identification and analysis of problems in the managed information system 202 is triggered by actual degradation in end-user application performance and experience. Unnecessary analysis, and false detection of problems that may not be reflected in any degradation in performance of the system 202, from the end-user perspective, may thereby be avoided.

The preferred embodiment of the management system 100 is also able to provide customised system views 212 of the managed information system 202 to operators and managers 214 of the information system 202. The customised system views may include various graphical representations of system performance indicators, such as gauges, tables and the like. It is also possible, in preferred embodiments of the present invention, to provide an operator with a video playback of actions leading up to, and during, an end-user experience degradation event.

Particular views of the system may incorporate forecasts 216 of pre-detected system performance, which may be based upon past performance of the system. The forecast data may be provided for the purposes of report generation 218, and for generating real-time alerts 220 to potential problems in the managed information system 202. When problems do arise the forecasts 216 and results of root cause analysis 222 may be used to identify a possible automated correction for the problem 224.

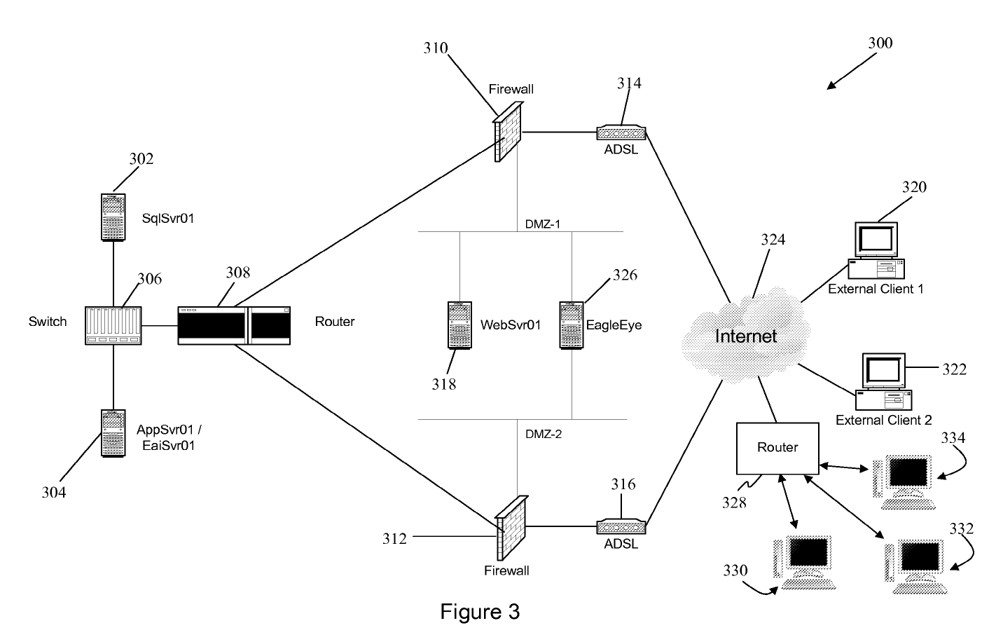

FIG. 3 illustrates an example of an information system 300 under management in accordance with a preferred embodiment of the invention. The exemplary information system 300 includes database server 302 and application server 304 connected via a network switch 306 to an Internet router 308. These critical enterprise components are protected by firewalls 310, 312 and have redundant connections 314, 316 to the Internet 324.

A web server 318 is provided outside firewalls 310, 312 in order to provide access to the information system by external clients, e.g. 320, 322 via the Internet 324.

The management system executes on server 326, which may comprise one or more computers each having one or more microprocessors and associated peripherals, such as network interfaces for connection to the system under management, and volatile and non-volatile storage (e.g. system memory and storage media such as hard disk drives) for the storage, loading and execution of programs and data implementing an embodiment of the invention.

Steps carried out in order to bring the information system 300 under the management of the management system executing on server 326, and further aspects of the ongoing operation of the management system, are described in greater detail in U.S. Pat. No. 7,953,847, and will therefore not be repeated herein.

In addition to the fixed external clients 320, 322, the system 300 also includes a router 328 which may be located, for example, at a remote site within an organisation's branch network. End-users throughout the branch network access the enterprise services provided by the applications server 304, and other components of the central office, via the Internet 324. In the exemplary system 300, three end-user terminals 330, 332, 334 are shown connected to the router 328 at the remote site.

It is desired to monitor end-user application performance, as experienced at any one of the terminals 330, 332, 334. One approach would be to dedicate an additional terminal at each site to the performance monitoring function. However, this is an inefficient use of space, facilities, and other resources.

Accordingly, embodiments of the invention make use of existing resources within the branch network, in particular by providing an integrated applications execution environment within selected network elements, such as the router 328, which are located at the branch sites, i.e. proximate to the end-user terminals 330, 332, 334. The integrated applications execution environment provided within the router 328 is configured to operate substantially independently of its primary network operations function, i.e. the routing of packets between the Internet 324 and the end-user terminals 330, 332, 334.

FIG. 4 is a block diagram 400 illustrating an architecture of the router 328 according to an embodiment of the invention. The network element 400 comprises the router 402, which is interconnected via a high-speed backplane 404 with one or more computing platforms 406, 408. Each computing platform, e.g. 408, comprises one or more central processing units 410, operably interfaced to a volatile memory device 422, such as random access memory (RAM). The processor 410 is also operably interfaced to a non-volatile storage device 414, such as a hard disk drive, or a solid state memory, such as a flash memory device. A further interface 416 is provided between the processor 410 and the high-speed backplane 404.

The network element 400 may be implemented, for example, using second generation Integrated Services Routers (ISR G2), available from Cisco Systems, Inc of San Jose, Calif. The Cisco ISR G2 provides a blade server chassis capable of hosting one or more Cisco Service Ready Engine (SRE) x86 blades, which provide the computing platforms 406, 408. Advantageously, each SRE blade results in only a small increase in power consumption (stated as 50 watts per blade, according to Cisco specifications), and requires no increase in rack space or cabling. The SRE blades 406, 408 communicate with each other and the router 402 via the backplane 404, thereby eliminating the need for additional external cables. Assignment of Internet protocol (IP) addresses, switch ports, and all routing services may be added dynamically as required without the need to physically re-cable the blades.

A block diagram 500 illustrating an embodiment of a system configuration for monitoring end-use performance of an application is shown in FIG. 5. The system 500 comprises a data centre 502 connected to a wide area network 504, i.e. the Internet. At a remote branch site end-user terminals 330, 332, 334 are connected to the wide area network 504 via the router 402 and a switch 506. The router 402 is connected, via the high-speed backplane 404, to the physical hardware computing platform 408.

In accordance with this embodiment of the invention, the physical hardware 408 is configured to support a virtual server environment. According to this approach, a hypervisor 508 executes on the physical hardware 408. For example, in the case of the Cisco SRE x86 blade, the VMware vSphere Hypervisor is used to provide a server virtualisation platform. Advantageously, server virtualisation via hypervisor 508 provides attributes traditionally lacking in conventional servers. For example, a virtual server is confined to a single container, and is unaware of other virtual servers (isolation). A virtual server may share hardware concurrently with other virtual servers (multiplicity). Virtual servers may be hardware independent, so that they are able to execute on various platforms (abstraction). Additionally, a virtual server is able to store its complete execution state in a file (encapsulation). All of these attributes are beneficial for end-user application performance monitoring. For example, a single physical hardware platform 408 may be used to emulate through virtualisation one or more ‘real’ end-user client terminals, each of which may be executing different applications, without the need to install corresponding duplicated hardware components within the branch network.

The hypervisor 508 is a thin software layer lying between the server hardware 408 and the operating system 510. A virtual client application 512 then executes within the environment provided by the operating system 510. The end-user application 512 is completely unaware that it is executing on a virtualised platform, which may also be supporting one or more independent virtual servers with their own operating systems and virtual client applications.

According to embodiments of the invention, a monitoring process 514 also executes within each virtual server environment. The monitoring process 514 emulates a ‘real’ user, providing inputs to the application 512 corresponding with actual user inputs (e.g. key presses, pointer movements, mouse clicks and so forth), and capturing images of corresponding displays generated by the application 512 in response to the emulated user actions. As will be appreciated, there is no requirement for the hardware platform 408 to provide any actual user input and/or display interfaces or devices, and these are all generally emulated within the virtualised server environment.

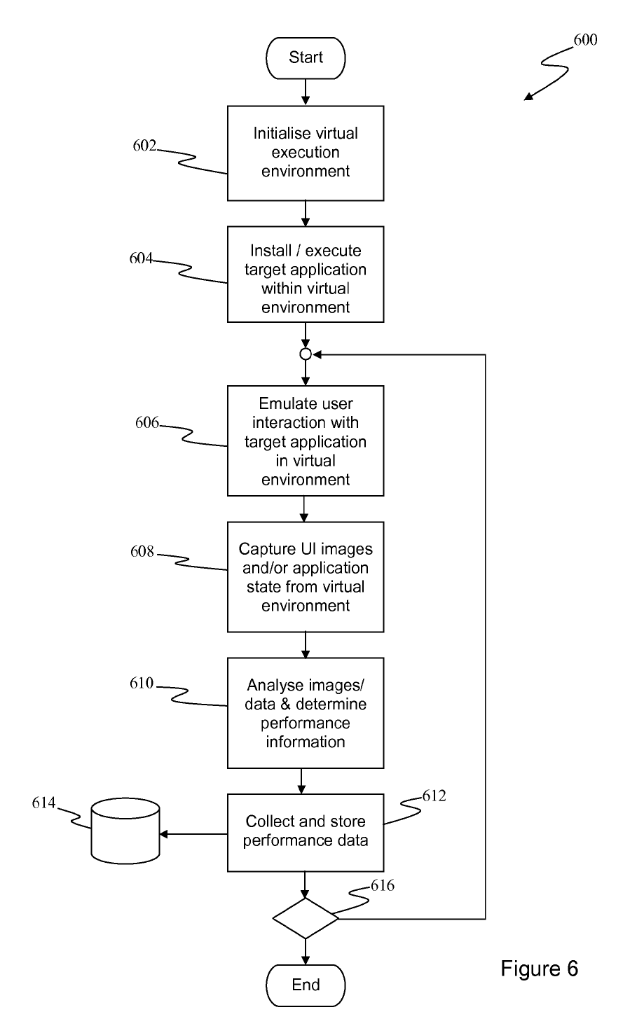

FIG. 6 is a flowchart 600 illustrating the process for router-based monitoring of the performance of one or more applications according to an embodiment of the invention. The first step of the process 600 is to initialise the virtual execution environment 602. At step 604 one or more target applications, e.g. 512, are installed and executed.

Once the target application is executing within the virtualised environment, the main monitoring process commences. At step 606 the monitoring process 514 emulates user interactions with the target application 514 within the virtual environment. At step 608, virtual user interface display images generated by the application 512 responsive to the emulated user actions are captured.

At step 610, the captured user interface images are analysed to determine relevant performance data of the application 512.

The captured images may be analysed, for example, in order to identify the presence of expected user interface elements. The monitoring process 514 is thus able to determine a range of relevant measures of performance and of end-user experience of the application 512. For example, the delay between providing inputs to the application 512 and an anticipated response, such as the update of a display with requested information, may be measured. The failure of an input action to produce an expected or desired response may also be detected. For example, analysis of captured images may be used to identify the presentation of an error or warning message, in place of a desired response.

At step 612, the performance data resulting from analysis of captured images may be stored in a database 614. The performance data will also typically be transferred, either subsequently, or in real-time, to the PAL 134 for further processing by the management system 100. In a typical embodiment, the user experience and performance data comprises REs that are available as input for computing relevant KPIs and KBIs within the monitoring and management system.

If continuous monitoring is to be performed (step 616), the process then returns to step 606.

It is also possible to store and process sequences of user interface images captured from the virtualised application. These sequences of images may be processed to create playable video files of the virtualised application display, and stored within the database 614. At any time, these video sequences may be retrieved for playback, in order to provide an operator with an effective visual record of the precise nature of the end-user experience of the application 512. Where any performance degradation is detected by the monitoring and management system, the actual impact on a user of the application 512 may be observed by viewing the corresponding video sequence.

In conclusion, methods, systems and software components have been described that are uniquely able to bring the monitoring of end-user performance of applications executing within a distributed branch network into the framework of a sophisticated information system management and monitoring platform 100. Embodiments of the invention enable this to be achieved with minimal impact at individual branch sites, by incorporating a suitable integrated applications execution environment within which the monitoring is conducted into an existing network element, such as a router. In this way, additional power consumption is minimised, and the usage of space, facilities and other resources within the branch network is optimised.

While particular preferred embodiments of the invention have been described, it will be appreciated that many variations to these embodiments are possible, and within the capabilities of the person skilled in the art, such as the use of different software platforms, different hardware and network technologies, and so forth. As such, the disclosed embodiments are not to be taken as limiting of the scope of the invention, which is defined by the claims appended hereto.

1. A method of obtaining end-user performance data associated with a target application executing at a predetermined location within a distributed information system, the method comprising the steps of:
providing a network element of the distributed information system proximate to the predetermined location, which is configured to provide a primary network operations function, and which further comprises an integrated applications execution environment configured to operate substantially independently of the primary network operations function;
executing the target application within the integrated applications execution environment;
performing at least one automated operation of the target application by emulating user actions within the integrated applications execution environment;
capturing one or more images of a target application virtual display from within the integrated applications' execution environment, comprising a graphical user interface responsive to the emulated user actions;
determining performance data of the target application by analysis of the captured images of the target application virtual display; and
storing the performance data in a memory store.

2. The method of claim 1 wherein the network element is a router.

3. The method of claim 1 wherein performing at least one automated operation includes the execution of emulated keyboard and pointer actions.

4. The method of claim 1 wherein performing at least one automated operation of the target application comprises generating an input event to the target application via the integrated applications execution environment.

5. The method of claim 1 wherein analysis of captured images comprises capturing one or more images, and analysing the images to detect a response to the emulated user actions.

6. The method of claim 5 wherein response data determined by analysis of images includes:
whether there is any response to the emulated user actions;
latency between an emulated user action and a corresponding response; and
whether a response to the emulated user actions is an expected response or an unexpected response.

7. The method of claim 1 wherein data gathered by the analysis of images captured from within the integrated applications execution environment is used to compute derived performance indicators of the system, including the target application.

8. The method of claim 1 wherein sequences of captured images are processed to generate a digital video recording of emulated user actions and corresponding application responses.

9. The method of claim 8 further including the step of playing said video sequences in real-time and/or storing said video sequences for later retrieval and viewing.

10. A system for obtaining end-user performance data associated with a target application executing at a predetermined location within a distributed information system, the system comprising:
a network element of the distributed information system proximate to the predetermined location, which is configured to provide a primary network operations function, and which further comprises an integrated applications execution environment configured to operate substantially independently of the primary network operations function,
wherein the integrated applications execution environment comprises a virtual client computing platform including a microprocessor and at least one associated memory device comprising stored program instructions and associated data, which when executed by the microprocessor cause the integrated applications execution environment to execute the steps of:
executing the target application on the virtual client computing platform;
performing at least one automated operation of the target application by emulating user actions within the integrated applications execution environment;
capturing one or more images of a target application virtual display from within the integrated applications execution environment, comprising a graphical user interface responsive to the emulated user actions;
determining performance data of the target application by analysis of the captured images of the target application virtual display; and
storing the performance data in a memory store.

11. The system of claim 10 wherein the memory store is co-located with the network element.

12. The system of claim 10 wherein the memory store is remotely located.
